(19) United States
(12) Patent Application Publication
(10) Pub. No.: US 2011/0091162 A1
(43) Pub. Date: Apr. 21, 2011

(54) CONNECTOR HAVING AN FLOATABLE OPTICAL MODULE

(75) Inventors: JIA-YONG HE, Kunshan (CN); QI-SHENG ZHENG, Kunshan (CN)

(73) Assignee: HON HAI PRECISION INDUSTRY CO., LTD., Tu-Cheng (TW)

(21) Appl. No.: 12/907,994

(22) Filed: Oct. 20, 2010

(30) Foreign Application Priority Data
Oct. 20, 2009 (CN) 200910308481.1

(51) Int. Cl. G02B 6/38

(52) U.S. Cl. 385/75

(57) ABSTRACT

A connector (100) includes an insulative housing (1) having a receiving slot (141) formed therein; an optical module (3) for transmitting optical data and being movably received in the receiving slot; a metal spring member (4) sandwiched between the insulative housing and the optical module for biasing the optical module to move in the receiving slot (141); a metal shell (7) shielding the insulative housing; and a shorting member (40) electrically connecting the spring member (4) and the metal shell (7).

### BACKGROUND OF THE INVENTION

1. Field of the Invention

The present invention relates to a connector, more particularly to a connector having an optical module for transmitting optical data.

2. Description of Related Art

At present, Universal Serial BUS (USB) is a widely used input/output interface adapted for many electronic devices, such as personal computer and related peripherals. In 1994, Intel, HP, IBM, NEC etc. together founded USB-IF to define a spec of USB. Nowadays, USB-IF has published several editions for USB, and transmitting rate of USB has became higher and higher. As development of electronic industry, higher transmitting rate of USB based connection accessory is needed.

An optical universal serial bus (OUSB) has been disclosed to be adopted for optical data transmission. The OUSB includes a USB connector with a number of lenses embedded in the USB connector and further connected with respective fibers for transmitting optical signal. Therefore, the OUSB can transmit signals up to 10 Gbps. However, as the lens are fixed to the USB connector, and they may fail to mate with counterparts if excessive clearance exits in manufacturing process.

Hence, an improved connector with a floatable optical module is desired to overcome the above problems.

### BRIEF SUMMARY OF THE INVENTION

According to one aspect of the present invention, a connector comprises: an insulative housing having a receiving slot formed therein; an optical module for transmitting optical data and being movably received in the receiving slot; a metal spring member sandwiched between the insulative housing and the optical module for biasing the optical module to move in the receiving slot; a metal shell shielding the insulative housing; and a shorting member electrically connecting the spring member and the metal shell.

According to another aspect of the present invention, a connector comprises: an insulative housing having a base portion and a tongue portion extending forwardly from the base portion, the tongue portion having a receiving slot recessed downwardly from an upper surface thereof; a plurality of contacts retained in a lower surface of the tongue portion; an optical module for transmitting optical data and being movably received in the receiving slot along a front-to-back direction; a metal spring member being retained in the insulative housing for forwardly biasing the optical module; and a metal shell shielding the tongue portion and covering the receiving slot. Wherein the spring member and the metal shell are electrically connected with each other via a shorting member.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is an assembled, perspective view of a connector according to a first embodiment of the present invention;

FIG. 2 is an exploded perspective view of the connector shown in FIG. 1;

FIG. 3 is similar to FIG. 2, but viewed from another aspect;

FIG. 4 is a partially assembly view of the connector shown in FIG. 1;

FIG. 5 is a cross-sectional view of the connector taken along line 5-5 shown in FIG. 1;

FIG. 6 is an assembled, perspective view of a connector according to a second embodiment of the present invention;

FIG. 7 is a partially assembly view of the connector shown in FIG. 6;

FIG. 8 is a partly exploded perspective view of the connector shown in FIG. 7;

FIG. 9 is a cross-sectional view of the connector taken along line 9-9 shown in FIG. 6;

FIG. 10 is an assembled, perspective view of a connector according to a third embodiment of the present invention;

FIG. 11 is a partially assembly view of the connector shown in FIG. 10; and

FIG. 12 is a cross-sectional view of the connector taken along line 12-12 shown in FIG. 10.

### DETAILED DESCRIPTION OF THE PREFERRED EMBODIMENT

In the following description, numerous specific details are set forth to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted inasmuch as such details are not necessary to obtain a complete understanding of the present invention and are within the skills of persons of ordinary skill in the relevant art.

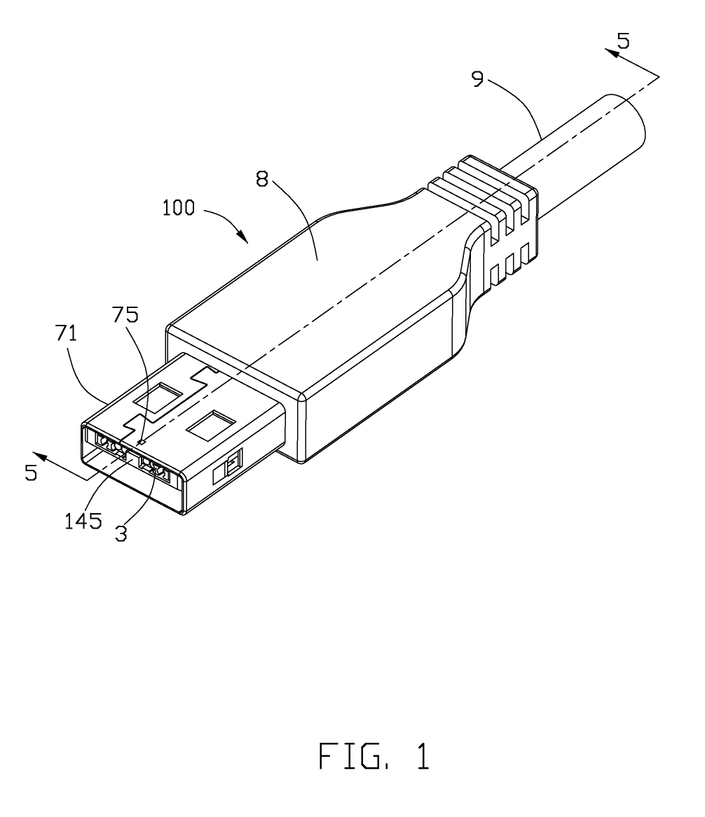

Referring to FIGS. 1-3, A connector 100 according to the present invention of a first embodiment is a plug of a USB connector cable assembly and comprises an insulative housing 1, a set of contacts 2 attached to the insulative housing 1, an optical module 3 for transmitting optical data and being coupled to the insulative housing 1, a compression coil spring 4 for urging the optical module 3 moving forwardly, a metal shorting member 40 seated on the compression coil spring 4, a spacer 5 retained in the insulative housing 1, an insulator 6 for engaging with the spacer 5, a shell 7 shielding the insulative housing 1, a plastic case 8 surrounding shell 7, and a cable 9 for electrical connection to the contacts 2. The shell 7 includes a first metal shell 71 and a second metal shell 72 coupled to the first metal shell 71.

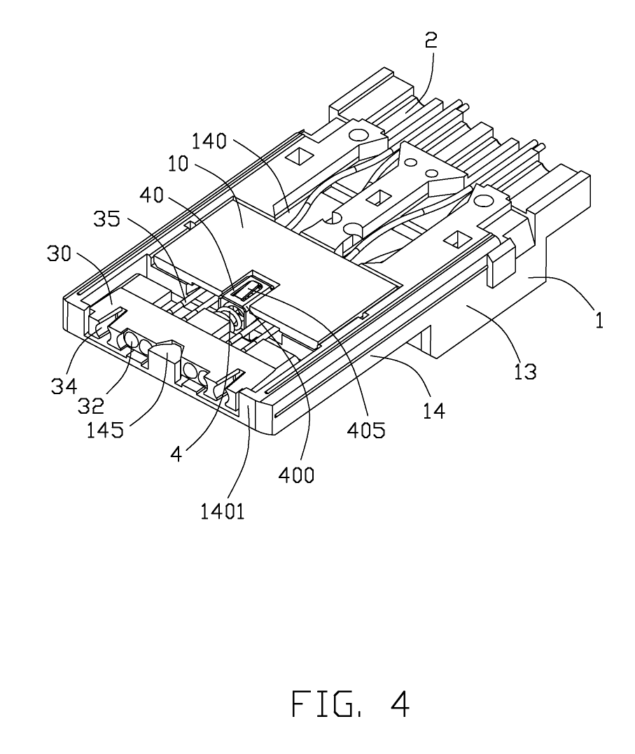

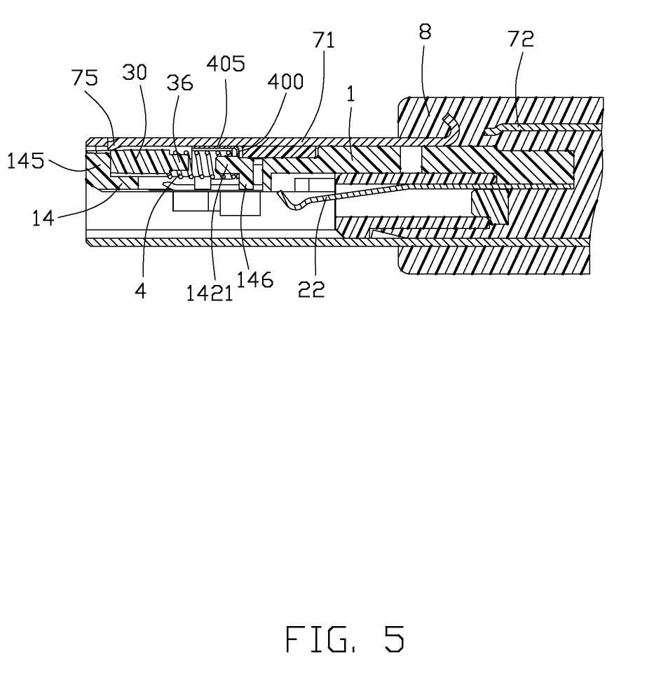

Referring to FIGS. 1-5, The insulative housing 1 includes a base portion 13 and a tongue portion 14 extending forwardly from a front end of the base portion 13. The base portion 13 has a depression 132 recessed upwardly from a lower surface thereof for retaining the spacer 5 and a set of retaining slots 131 formed on an upper surface for retaining the contacts 2. The tongue portion 14 has a receiving slot 141 recessed downwardly from an upper surface thereof, a recessed portion 144 recessed downwardly from the upper surface and located behind the receiving slot 141. The recessed portion 144 has a first groove 1442 recessed downwardly therefrom and forwardly communicating with the receiving slot 141, a set of narrower second grooves 143 located behind the first groove 1442 and communicating with the first groove 1442, and a cavity 142 recessed downwardly in the first groove 1442 and forwardly communicating with the receiving slot 141 for receiving the compression coil spring 4. The recessed portion 144 has a resisting wall 146 located behind the cavity 142 and a post 1421 extending forwardly from the resisting wall 146 into the cavity 142 for retaining a rear end of the compression coil spring 4. The tongue portion 14 has a reception groove 149 located under the receiving slot 141 and upwardly communicating with the receiving slot 141. The reception groove 149 is located under a front end of the compression coil spring 4 to provide a space for the compression coil spring 4 vibrating in a height direction of the connector 100. The insulative housing 1 has a pair of third grooves 140 located behind the second grooves 143 and forwardly communicating with the second grooves 143. The third groove 140 is wider than the second groove 143 and narrower than the first groove 1442 in a transverse direction. The tongue portion 14 has a V-shaped first stopping portion 145 located at front and midst of the receiving slot 141, a pair of second stopping portions 1401 located at front and two sides of the receiving slot 141, and a pair of protrusions 147 formed at two lateral sides of the first stopping portion 145 and between the second stopping portions 1401. The V-shaped first stopping portion 145 gradually reduces from a widest front end to a narrowest back end. The protrusion 147 protrudes upwardly into the receiving slot 141. A set of first passageways 1481 and a set of second passageways 1482 are formed at a lower surface of the tongue portion 14 in a condition that the first passageways 1481 are arranged in a front row along the transverse direction and the second passageways 1482 are arranged in a rear row parallel to the front row. The connector 100 further comprises a cover 10 retained in the recessed portion 144. The cover 10 has a pair of cylinders 101 integrally extending therefrom for being retained into a pair of receiving holes 1441 formed on the recessed portion 144, and an opening 102 corresponding to the cavity 142.

The shorting member 40 includes a first mating portion 400 seated on the compression coil spring 4 for contacting with the compression coil spring 4 and a second mating portion 405 for contacting with the first metal shell 71. The first mating portion 400 is retained in the cavity 142 and the opening 102, and includes a top plate 401 over the compression coil spring 4, a pair of side plates 402 extending downwardly from two lateral sides of the top plate 401, and a rear plate 403 extending downwardly from a rear end of the top plate 401. The rear plate 403 has a perforation 4031 for the post 1421 passing through and is resisted backwardly by the compression coil spring 4 so as to contact with the compression coil spring 4 reliably. The second mating portion 405 is integrally stamped from the top plate 401 and extends obliquely upwardly for contacting with the first metal shell 71. The first metal shell 71 and the compression coil spring 4 are electrically connected with each other via the shorting member 40, therefore, static electricity created on the compression coil spring 4 could be eliminated via the first metal shell 71.

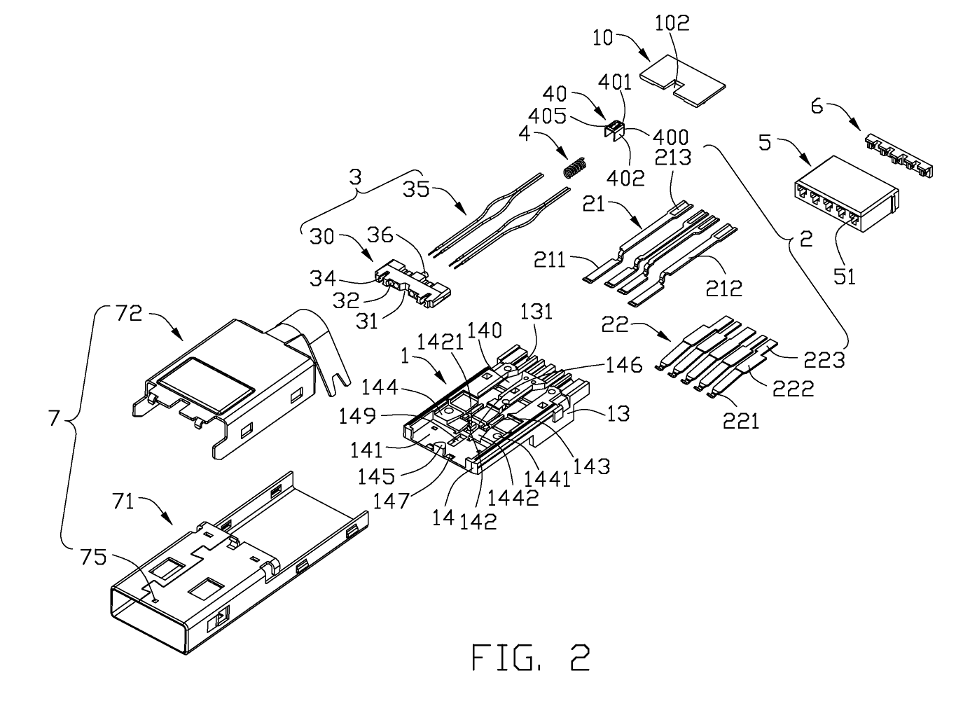

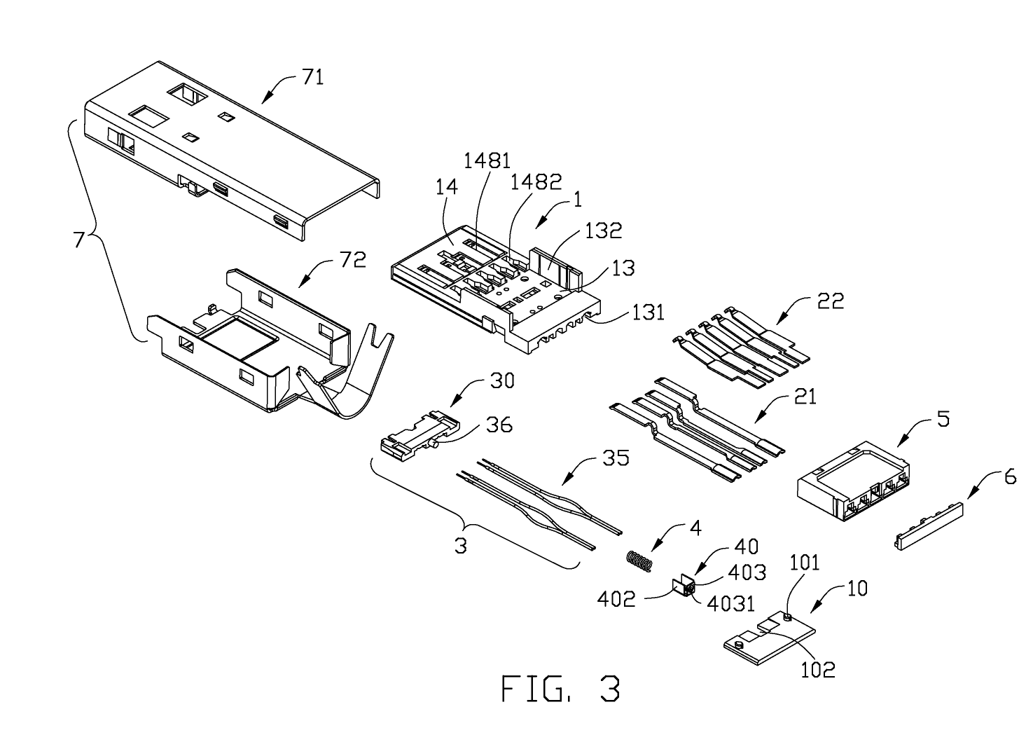

Referring to FIGS. 2 to 3, the contacts 2 are adapted for USB 3.0 protocol, and include a number of first contacts 21 and a number of second contacts 22. The first contacts 21 are adapted for USB 2.0 protocol and each includes a stiff first contacting portion 211 retained in the first passageway 1481, a first tail portion 213 for electrical connection to the cable 9, and a first connecting portion 212 connecting the first contacting portion 211 and the first tail portion 213 and being retained in the base portion 11. The second contacts 22 include two pair of differential contacts and a grounding contact located between the two pair of differential contacts. Each second contact 22 includes a resilient second contacting portion 221 received in the second passageway 1482, a second tail portion 223 for electrical connection to the cable 9, and a second connecting portion 222 connecting the second contacting portion 221 and the second tail portion 223 and being retained in a corresponding through hole 51 of the spacer 5. The insulator 6 is retained in the spacer 5 to retain the second contacts 22 in the spacer 5 firmly. In this embodiment, the first contacts 21 are assembled to the insulative housing 1, the second contacts 22 are assembled to the spacer 5 and form as a module so as to be assembled to the insulative housing 1, in other embodiment, the first contacts 21 could be insert molded into the insulative housing 1, the second contacts 22 could be insert molded with the spacer 5 and form as a module so as to be assembled to the insulative housing 1.

Referring to FIGS. 1-5, the optical module 3 comprises a main body 30 being movably received in the receiving slot 141 along a front-to-back direction which is perpendicular to the transverse direction, and a pair of fibers 35 attached to the main body 30 and received in the first, second, and third grooves 1442, 143, 140. The main body 30 has a V-shaped slot 31 recessed backwardly from a front face thereof and fitted in with the V-shaped first stopping portion 145, a set of lenses 32 attached to the main body 30 and located at two lateral sides of the V-shaped slot 31 for optically coupling with the fibers 35, and a pair of retaining holes 34 formed thereon and located at two lateral sides of the lenses 32 for accommodating a pair of columniations on a complementary receptacle so as to align the lenses 32 with lenses on the receptacle and transmit optical data therebetween reliably. A pole 36 protrudes backwardly from the main body 30 so as to be received in a front end of the compression coil spring 4. Therefore, the optical module 3 could be biased forwardly by the compression coil spring 4.

The fibers 35 have front parts received in the first slot 1442, middle parts retained in the second slots 143, and rear parts received in the third slots 140. The middle parts are retained in the second slots 143 firmly along the transverse direction. The first slot and third slots 1442, 140 which are wider than the second slots 143 will offer spaces for distortions of the front and rear parts.

Referring to FIGS. 2-5, the first metal shell 71 has a top wall defining a projection 75 projecting downwardly therefrom for abutting against the main body 30 downwardly so as to retain the main body 30 in the receiving slot 141.

When the connector 100 is inserted into the complementary receptacle for mating with the receptacle, the optical module 3 is pushed backwardly by the receptacle and moves backwardly in the receiving slot 141. Because the rear end of the compression coil spring 4 is retained in the post 1421 of the insulative housing 1, when the lenses 32 and the corresponding lenses on the receptacle are misaligned, the optical module 3 will vibrate in a height direction to make the lenses 32 align with the lenses on the receptacle and transmit optical data therebetween reliably, the reception groove 149 will offer a space for the optical module 3 vibrating in the height direction. When the connector 100 is extracted out from the complementary receptacle, the optical module 3 is biased forwardly by the compression coil spring 4 and moves forwardly in the receiving slot 141, the V-shaped first stopping portion 145 fits in with the V-shaped slot 31 for resisting the optical module 3 backwardly and sidewardly so as to prevent the optical module 3 moving in the front-to-back and transverse direction, the second stopping portions 1401 abut against the front face of the main body 30 to prevent the optical module 3 moving forwardly, the projection 75 abuts against the main body 30 downwardly and the protrusions 147 abut against the main body 30 upwardly so as to retain the optical module 3 therebetween. Therefore, the first stopping portion 145 and the second stopping portions 1401 present as a stopping device for orientating the optical module 3 in the front-to-back and the transverse direction, the protrusions 147 and the projection 75 present as a resisting device for orientating the optical module 3 in a height direction of the connector 100, the optical module 3 will be orientated on its original position firmly and accurately, and the optical data will be transmitted between the connector and the receptacle reliably.

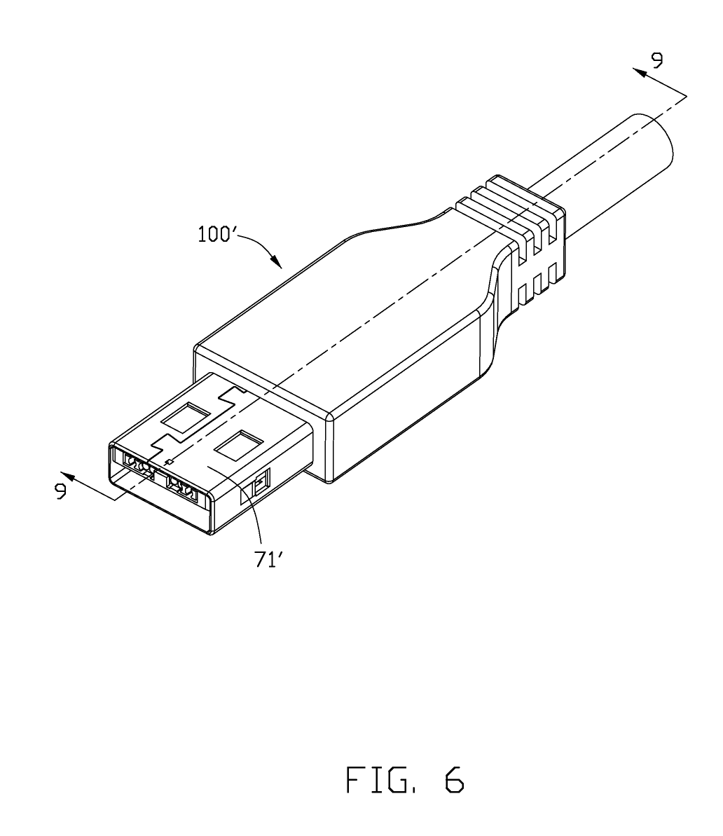

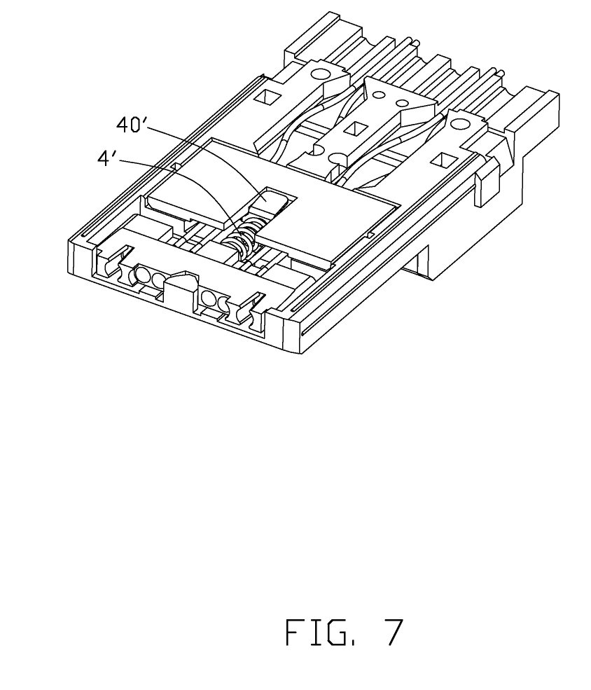

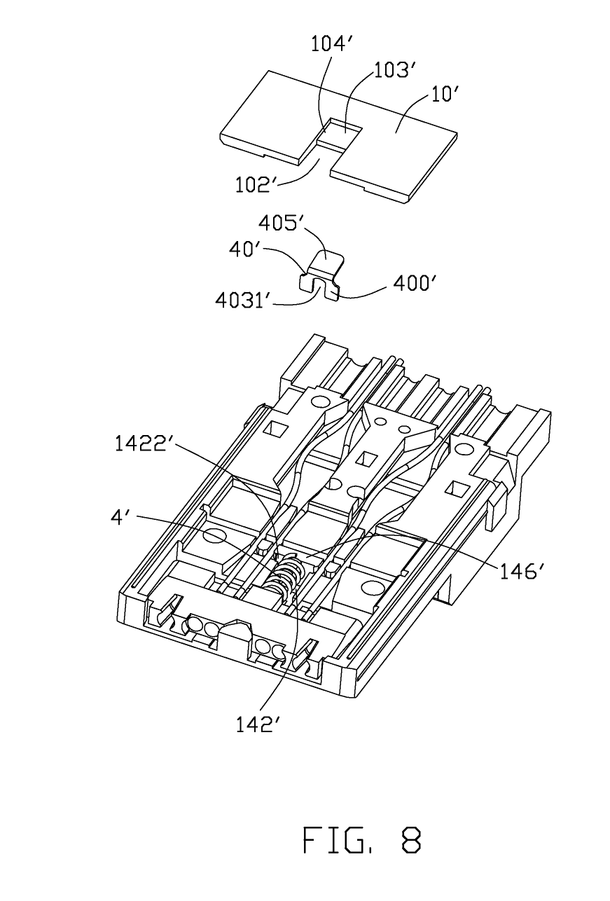

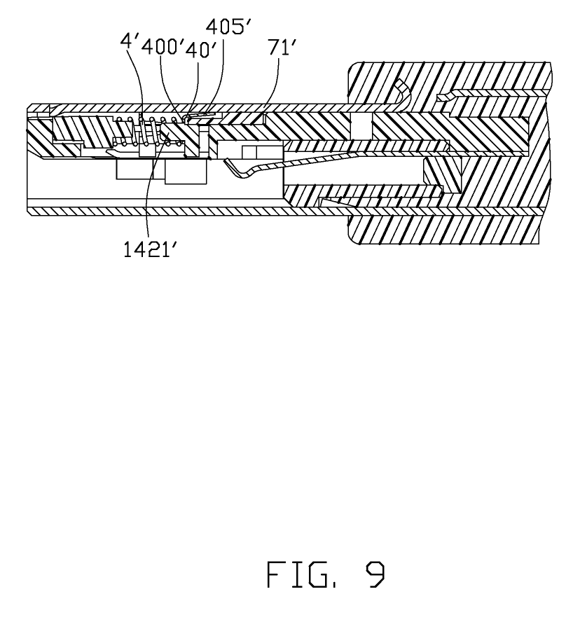

Referring to FIGS. 6-9, a connector 100′ according to a second embodiment of the present invention, only the shorting member 40′ has been modified. The first mating portion 400′ which contacting with the compression coil spring 4′ is a flat metal plate and is received in a fixing groove 1422′ formed on the resisting wall 146′ and communicating with the cavity 142′. The perforation 4031′ is recessed upwardly from a lower face of the first mating portion 400′ so that the post 1421′ can pass therethrough. The first mating portion 400′ is resisted backwardly by the compression coil spring 4′ so as to contact with the compression coil spring 4′ reliably. The second mating portion 405′ extends obliquely upwardly from an upper face of the first mating portion 400′ and protrudes out of the opening 102′ of the cover 10′ so as to contact with the first metal shell 71′. The cover 10′ has a recess 103′ recessed downwardly from an upper surface thereof and located behind the opening 102′ for retaining the second mating portion 405′. A supporting potion 104′ is located under the recess 103′ for resisting the first mating portion 400′ upwardly so as to prevent the first mating portion 400′ from over deformation.

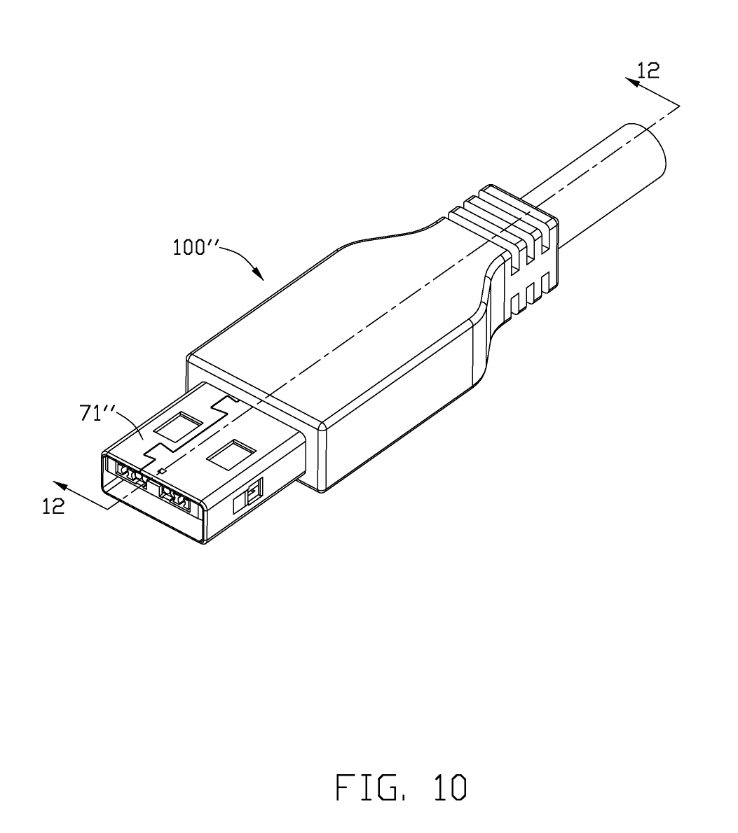

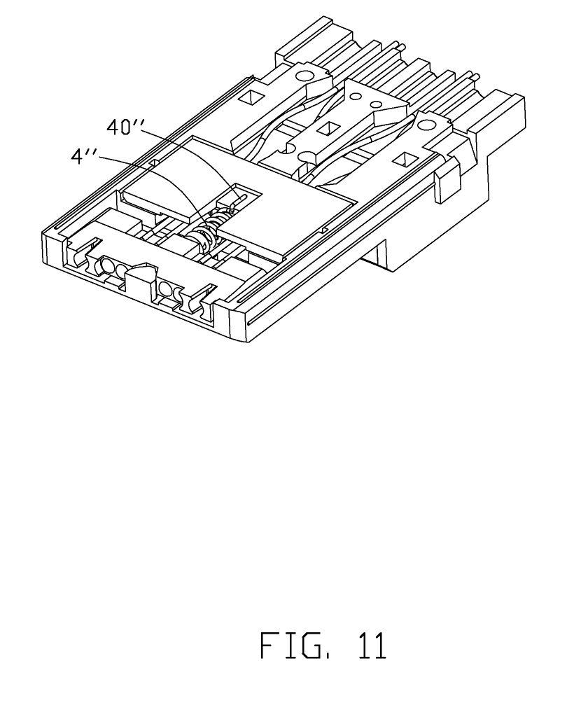

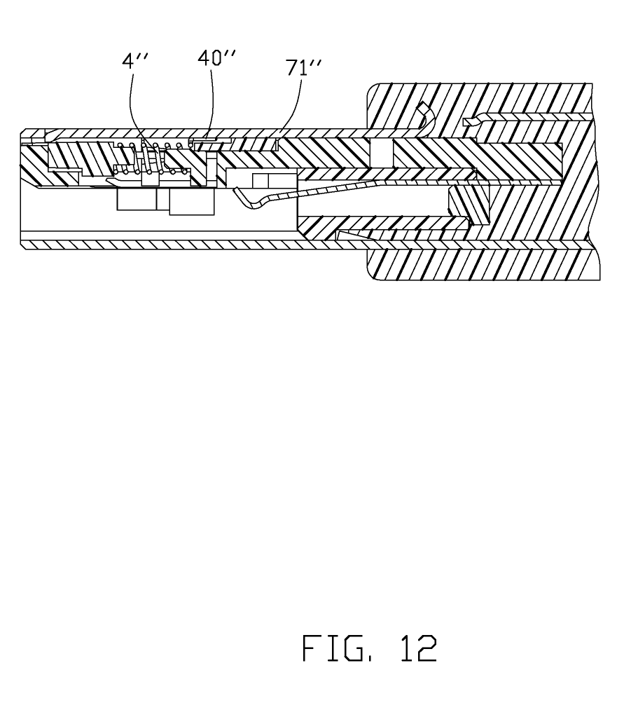

Referring to FIGS. 10-12, a connector 100″ according to a third embodiment of the present invention, only the shorting member 40″ has been modified. In this embodiment, the shorting member 40″ integrally extends from a rear end of the compression coil spring 4″ so as to contact with the first metal shell 71″. Therefore, the number of components of the connector 100″ is decreased, the cost of production is diminished.

In other embodiments, the coil compressions 4 could be other spring members such as torsion coil spring, elastic plate, etc, and the connector 100 could be a receptacle connector.

It is to be understood, however, that even though numerous, characteristics and advantages of the present invention have been set fourth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

What is claimed is:

1. A connector comprising:
an insulative housing having a receiving slot formed therein;
an optical module for transmitting optical data and being movably received in the receiving slot;
a metal spring member sandwiched between the insulative housing and the optical module for biasing the optical module to move in the receiving slot;
a metal shell shielding the insulative housing; and
a shorting member electrically connecting the spring member and the metal shell.

2. The connector according to claim 1, wherein the shorting member comprises a first mating portion retained in the insulative housing for contacting with the spring member and a second mating portion for contacting with the metal shell.

3. The connector according to claim 2, wherein the insulative housing has a cavity located behind the receiving slot and communicating with the receiving slot, the spring member and the second mating portion are received in the receiving slot.

4. The connector according to claim 3, wherein the second mating portion comprises a top plate over the spring member, a pair of side plates extending downwardly from two lateral sides of the top plate, and a rear plate extending downwardly from a rear end of the top plate, the second mating portion is integrally stamped from the top plate and extends obliquely upwardly for contacting with the metal shell.

5. The connector according to claim 4, wherein the insulative housing has a resisting wall located behind the cavity for resisting the rear plate forwardly, the spring member resist the rear plate backwardly so as to contact with the shorting member reliably.

6. The connector according to claim 5, wherein the spring member is a compression coil spring, the insulative housing has a post extending forwardly into the cavity from the resisting wall for retaining a rear end of the compression coil spring, the rear plate has a perforation for the post passing through.

7. The connector according to claim 2, wherein the first mating portion is a flat metal plate and is sandwiched between the spring member and a resisting wall formed on the insulative housing, the second mating portion extending obliquely upwardly from an upper face of the first mating portion for contacting with the metal shell.

8. The connector according to claim 7, wherein the connector comprises a cover retained in the insulative housing, the cover has an opening for the second mating portion passing through, a recess recessed downwardly and located behind the opening for receiving the first mating portion, the recess defines a supporting portion locating under the recess for resisting the first mating portion upwardly so as to prevent the first mating portion from downward over deformation.

9. The connector according to claim 1, wherein the shorting member integrally extends from the spring member.

10. The connector according to claim 1, wherein the insulative housing has a base portion and a tongue portion extending forwardly from the base portion, the receiving slot is recessed downwardly from an upper surface of the tongue portion, the optical module comprises a main body being movably received in the receiving slot and biased by the spring member, a set of lenses attached to the main body and exposed to exterior, and a set of fibers attached to the main body for optically coupling with the lenses.

11. The connector according to claim 10, wherein the connector comprises a plurality of contacts retained on a lower surface of the tongue portion for transmitting electrical data.

12. The connector according to claim 10, wherein the tongue portion has a V-shaped first stopping portion formed at front of the receiving slot, the V-shaped first stopping portion gradually reduces from a widest front end to a narrowest back end, the optical module has a V-shaped slot recessed backwardly from a front face thereof for accordantly accommodating the V-shaped first stopping portion.

13. A connector comprising:
an insulative housing having a base portion and a tongue portion extending forwardly from the base portion, the tongue portion having a receiving slot recessed downwardly from an upper surface thereof;
a plurality of contacts retained in a lower surface of the tongue portion;
an optical module for transmitting optical data and being movably received in the receiving slot along a front-to-back direction;
a metal spring member being retained in the insulative housing for forwardly biasing the optical module; and
a metal shell shielding the tongue portion and covering the receiving slot; wherein
the spring member and the metal shell are electrically connected with each other via a shorting member.

14. The connector according to claim 13, wherein the shorting member comprises a first mating portion retained in the insulative housing for contacting with the spring member and a second mating portion for contacting with the metal shell.

15. The connector according to claim 13, wherein the shorting member is integrally formed with the spring member.

16. A electrical connector for coupling to a complementary connector, comprising:
an insulative housing defining an optical transmission area and an electrical transmission area;
a metallic shell enclosing said housing;
a plurality of electrical contacts disposed around the electrical transmission area;
an optical module disposed around the optical transmission area, and back and forth moveable along a mating direction; and
a metallic resilient device constant urging said optical module forward;
wherein
said resilient device is electrically connected to said shell via a shorting member.

17. The electrical connector as claimed in claim 16, wherein said shorting member is unitarily formed with the resilient device.

18. The electrical connector as claimed in claim 16, wherein said shorting member is discrete from the resilient device.

19. The electrical connector as claimed in claim 16, wherein said shorting member is discrete from the shell.

20. The electrical connector as claimed in claim 16, wherein said shorting member is sandwiched between the shell and the resilient device.
